(19) United States
(12) Patent Application Publication
(10) Pub. No.: US 2026/0330517 A1
(43) Pub. Date: Oct. 22, 2026

(54) Generative Artificial Intelligence Systems and Methods for Automated Repair and Replacement Estimation

(71) Applicant: Xactware Solutions, Inc., Lehi, UT (US)

(72) Inventors: Jeffery D. Lewis, Orem, UT (US); Zeke S. Smith, Spanish Fork, UT (US); Brandon O'Very, Saratoga Springs, UT (US)

(73) Assignee: Xactware Solutions, Inc., Lehi, UT (US)

(21) Appl. No.: 19/468,394

(22) Filed: Feb. 3, 2026

Related U.S. Application Data
(60) Provisional application No. 63/753,194, filed on Feb. 3, 2025.

(51) Int. Cl. G06Q 30/0283; G06F 30/12; G06F 30/13; G06F 30/27; G06Q 10/20

(52) U.S. Cl. CPC G06Q 30/0283; G06F 30/12; G06F 30/13; G06F 30/27; G06Q 10/20

(57) ABSTRACT

Generative artificial intelligence systems and methods for automated repair and replacement estimation are provided. The system includes an estimation processor and an estimate generation software engine executed by the estimation processor, which automatically generates an estimate for repairing and/or replacing one or more components of a structure such as a roof of a building or other components of the structure. The system generates a model of the structure, processes the model of the structure to determine components of the structure, and automatically generates an estimate for repairing or replacing the components of the structure. The system can obtain data from a wide variety of data sources including weather data sources, city data sources, and other data sources, each of which are in electronic communication with the estimate generation engine. The system can generate an automatic roof summary as well as detailed repair and/or replacement line items.

### RELATED APPLICATIONS

The present application claims the benefit of U.S. Provisional Application Ser. No. 63/753,194 filed on Feb. 3, 2025, the entire disclosure of which is expressly incorporated herein by reference.

### BACKGROUND

### Technical Field

The present disclosure relates generally to the field of artificial intelligence. More specifically, the present disclosure relates to generative artificial intelligence systems and methods for automated repair and replacement estimation.

### Related Art

In the insurance field, the ability to rapidly develop accurate estimates for repairing and replacing damaged items associated with an insurance claim is paramount. Examples of such items include repairing or replacing damaged components of a building such as roof components, building components, and other damage to structures or property. While there are existing software-based systems that can be utilized to assist insurance adjusters and/or other professionals in developing such estimates, the process can be time-consuming and efficient not only from the perspective of the user (due to manual data entry tasks that are often required) but also from the perspective of wasted computing resources and time.

The field of artificial intelligence, and in particular, generative artificial intelligence, is growing tremendously, and technologies in these areas are rapidly enhancing the speed with which useful data can be generated. However, such technologies have not yet effectively been incorporated into computer-based insurance claims adjustment software, where there is a significant need for improving the speed and accuracy of such software.

Accordingly, what would be desirable, but have not yet been provided, are generative artificial intelligence systems and methods for automated repair and replacement estimation, which solve the foregoing and other needs.

### SUMMARY

The present disclosure relates to generative artificial intelligence systems and methods for automated repair and replacement estimation. The system includes an estimation processor and an estimate generation software engine executed by the estimation processor, which automatically generates an estimate for repairing and/or replacing one or more components of a structure such as a roof of a building or other components of the structure. The system generates a model of the structure, processes the model of the structure to determine components of the structure, and automatically generates an estimate for repairing or replacing the components of the structure. The system can obtain data from a wide variety of data sources in order to automatically generate the estimate, including weather data sources, city data sources, and other data sources, each of which are in electronic communication with the estimate generation engine. The system can generate an automatic roof summary as well as detailed repair and/or replacement line items.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating processing steps carried out by the systems and methods of the present disclosure;

FIG. 3 is flowchart illustrating step 32 of FIG. 2 in greater detail;

FIG. 4 is a flowchart illustrating additional processing steps carried out by the systems and methods of the present disclosure;

FIG. 5 is a table illustrating mapping by the systems and methods of the present disclosure of model components to various attributes including material types, faces, and additional data;

FIG. 6 is a screenshot illustrating a user interface screen generated by the systems and methods of the present disclosure wherein a model of a structure is created and is utilized to automatically create an estimate of elements of the structure;

FIG. 7 is screenshot illustrating another user interface screen generated by the systems and methods of the present disclosure, indicating that a model is being created by the system; and

FIG. 8 is screenshot illustrating another user interface screen generated by the systems and methods of the present disclosure, wherein a model of the structure has been created and processed by the system to automatically create a roof summary and a list of repair or replacement components associated with the structure.

### DETAILED DESCRIPTION

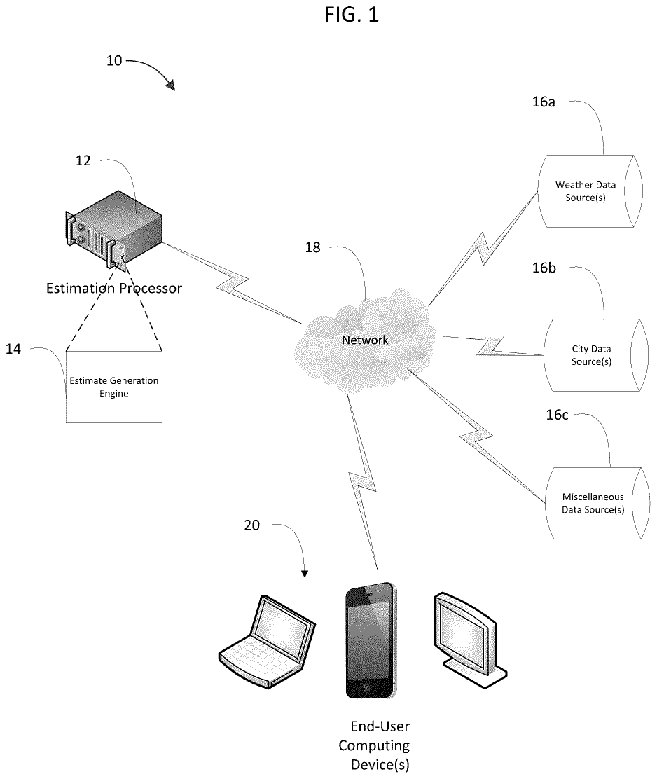

The present disclosure relates to generative artificial intelligence systems and methods for automated repair and replacement estimation, as discussed in detail below in connection with FIGS. 1-8.

FIG. 1 is a diagram illustrating the system of the present disclosure, indicated generally at 10. The system 10 includes an estimation processor 12 which executes an estimation generation software engine 14 to automatically generate models of structures, determine components of the structures (e.g., roof components, building components, materials, contents of the structure, etc.), and automatically generate lists of repair and/or replacement items for repairing or replacing such components, using generative artificial intelligence features programmed into the engine 14. The estimation processor 12 can be a suitable computer system including, but not limited to, a server, a cloud computing platform/service, a distributed processing system, a personal computer, a smart phone, a table computer, a microprocessor, a microcontroller, a graphics processing unit (GPU), a tensor processing unit (TPU), or other suitable computing device. The engine 14 could be embodied as non-transitory, computer-readable instructions stored in a non-transitory, computer-readable storage medium such as disk, memory, flash memory, or other suitable storage medium and executable by the processor 12. The engine 14 could be coded in any suitable high-or low-level computer programming language, including, but not limited to, C, C++, C#, Java, Javascript, Python, or other suitable programming language. Additionally, the engine 14 could be embodied as a custom hardware device, such as an application-specific integrated circuit (ASIC), field-programmable gate array (FPGA), or other suitable hardware device.

The processor 12 and the engine 14 communicate with one or more data sources 16a-16c including, but not limited to, weather data source(s) 16a, city data source(s) 16b, and miscellaneous data source(s) 16c to obtain information from such sources which can be utilized by the system to automatically generate models of structures, determine components of such structures, and generate lists of repair and/or replacement items for repairing or replacing the components of the structures. Each of the data sources 16a-16c could comprise databases that are hosted by one or more associated computer systems, each of which is electronically in communication with the processor 12 and the engine 14 via a suitable communications network, such as network 18. The network 18 could include, but is not limited to, a local area network (LAN), a wide area network (WAN), the Internet, a wireless (e.g., cellular data) network, or other suitable communications network. Still further, the data sources 16a-16c need not be remote from the processor 12, and indeed, could be databases and/or files that are stored in a memory forming part of, or associated with, the processor 12. The data sources 16a-16c could share information with the processor 12 and estimation engine 14 using suitable data exchange protocols and/or formats, such as extensible markup language (XML), one or more application programming interface (API) calls/requests, or other protocols/formats.

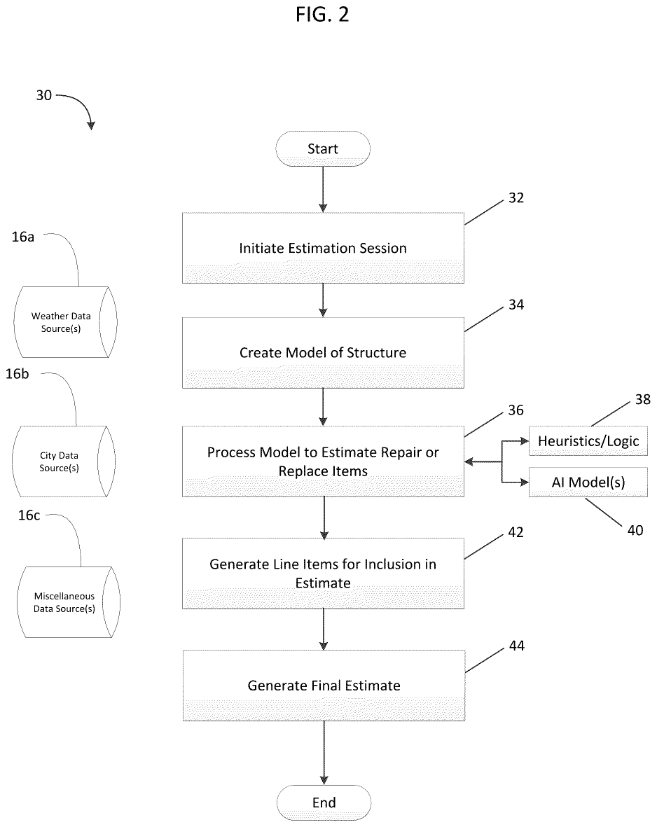

Output generated by the estimation engine is accessible by one or more end-user computing devices 20, which could include, but is not limited to, personal computers, laptop computers, servers, smart phones, etc. The output of the estimation engine 14 could be accessible on such devices using one or more software applications (“apps”) executed by the devices 20, and/or in a web-based interface that is hosted by the processor 12 or other device and accessible using a web browser executing on the devices 20. Still further, it is noted that the estimation generation engine 14 need not be executed by the processor 12, but could instead be stored on and executed by one or more of the end-user computing devices 20. The features of, and functions performed by, the system 10 are discussed in greater detail in connection with FIGS. 2-8.

FIG. 2 is a flowchart, indicated generally at 30, illustrating processing steps carried out by the systems and methods of the present disclosure. In step 32, the system initiates an estimation session, whereby the user identifies a structure for which estimate generation is desired and the system automatically obtains information from one or more of the data sources 16a-16c relevant to the structure and estimate generation therefor. Next, in step 34, a model of the structure is created. The model could be manually created by the user by sketching the structure in a user interface generated by the system, or it could automatically be created by the system using generative artificial intelligence which generates the model using textual and/or other descriptions of the structure provided by the user (e.g., in a conversational or chatbot-like interface).

In step 36, the system processes the model to determine components of the structure (e.g., roof or structure elements, roof materials, building materials, and other components of the structure) and automatically estimates items that are required to repair or replace such components of the structure. This is achieved using one or more heuristic or logic rules 38 and/or one or more trained artificial intelligence (AI) models 40. Then, in step 42, the system generates “line items” for inclusion in an estimate, which are discrete line entries that list one material or building component per line as well as information relating to the material or building component, such as the name of the item, item costs, insurance (e.g., “cat” and “sel”) codes associated with the item, and other information. Finally, in step 44, the system generates a final estimate, which can be displayed to the user in a user interface screen (e.g., displayed on and accessible by one or more of the end-user computer devices 20 of FIG. 1). Additionally, the final estimate can be electronically transmitted to a recipient or a remote computing device (e.g., to an insurer's computer system) for further processing by such recipients/devices.

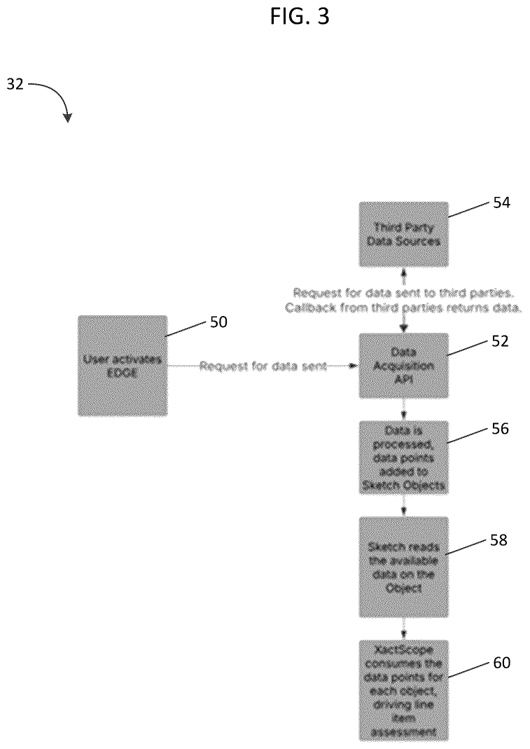

FIG. 3 is flowchart illustrating step 32 of FIG. 2 in greater detail. In step 50, a user activates the system (e.g., initiates a session on his/her computing device, such as the end-user computing devices 20) and identifies a structure for which modeling and estimation generation is desired. This causes the system to issue a data request over a data acquisition API 52 to one or more third-party data sources 54, which could include one or more of the data sources 16a-16c of FIG. 1. The request is sent to the third-party and a callback from the third party returns data via the API 52. In step 56, the returned data is processed, and data points are identified for use in creating a model (sketch) of the structure, and/or added to an existing model. In step 58, the system reads the available data on one or more components (objects) of the model. Then, in step 60, the system consumes the data points for each component (object) of the model, which is utilized in driving line item assessments generated by the system.

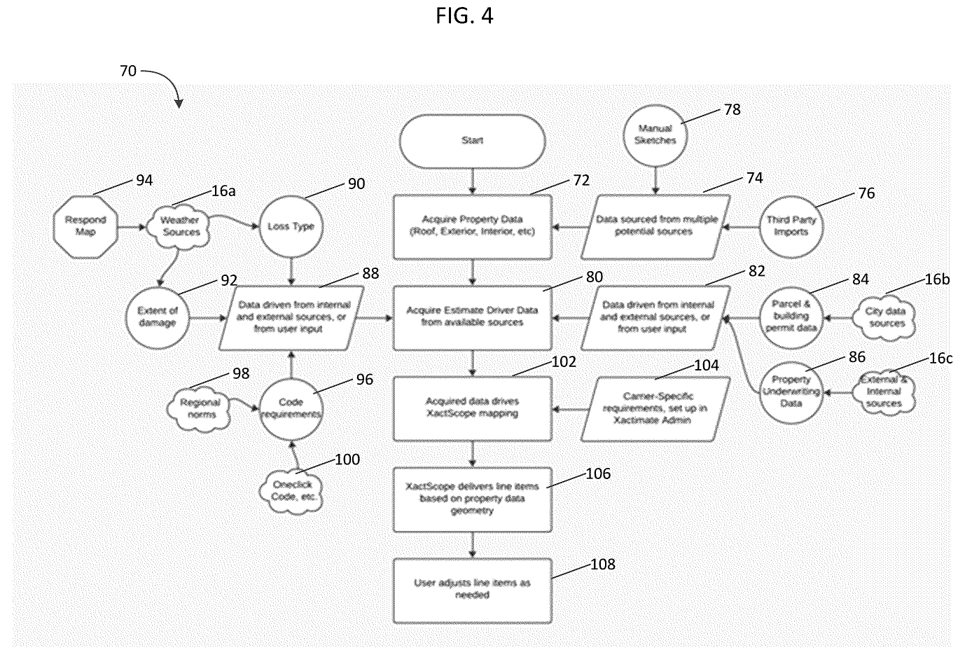

FIG. 4 is a flowchart, indicated generally at 70, illustrating additional processing steps carried out by the systems and methods of the present disclosure. In step 72, the system acquires property data relating to a structure to be modeled and for which estimate generation is desired. Such data could include roof information, information about the exterior of the property, information about the interior of the property, etc. The data could include data 74 sourced from multiple potential sources, such as third-party data imports 76 and/or manual sketches 78 of the structure, as well as models/sketches of the structure that are automatically generated by the system using one or more generative AI models.

In step 80, the system acquires “driver” data from one or more available sources, which is data that is used by the system to drive automatic generation of estimates (including automatic identification of components of the structure and repair/replace items and associated data for repairing or replacing such components). The driver data could include data 82 and data 88 driven from internal and external sources or from user input. The data 82 could include publicly-available parcel and/or building permit data 84 supplied by the city data source(s) 16b of FIG. 1, as well as property underwriting data 86 supplied by the miscellaneous data source(s) 16c of FIG. 1 (which could include internal and external data sources). The data 88 could include loss type data 90, extend of damage data 92, and code requirements data 96. The loss type data 90 and the extent of damage data 92 could be supplied from weather data source(s) 16a of FIG. 1, and the weather data source(s) 16a could be driven/controlled by a response map 94. The code requirements data 96 could be supplied from regional regulations/norms 98, as well as code sources 100 (including “one-click” code sources, etc.).

In step 102, the acquired data drives one or more mapping processes, wherein the acquired data automatically is mapped to one or more of the model components by the system. This step could be carried out using carrier-specific requirements data 104, which could be established in advance for an insurance carrier or other user of the system. In step 106, the system generates line items based on property data geometry, which indicate items for repair or replacement of one or more components of the modeled structure. In step 108, the user adjusts the line items as needed.

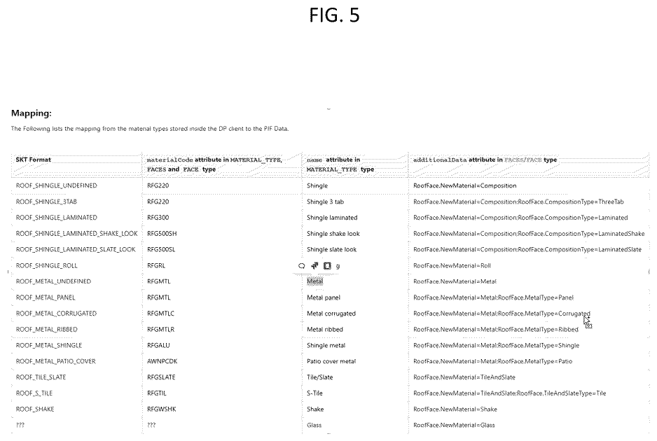

FIG. 5 is a table illustrating mapping by the systems and methods of the present disclosure of model components to various attributes including material types, faces, and additional data. The first column (“SKT Format”) identifies a model component, such as a roof shingle, roof tab, roof metal, roof slate, roof tile, or any other component of the structure being modeled. The second column identifies a material code associated with the model component. The third column identifies a name of the model component. The fourth column identifies other relevant information related to the model component. This mapping allows the system to automatically map estimation data (to be used on generating a repair or replacement estimate and associated line items) to model components.

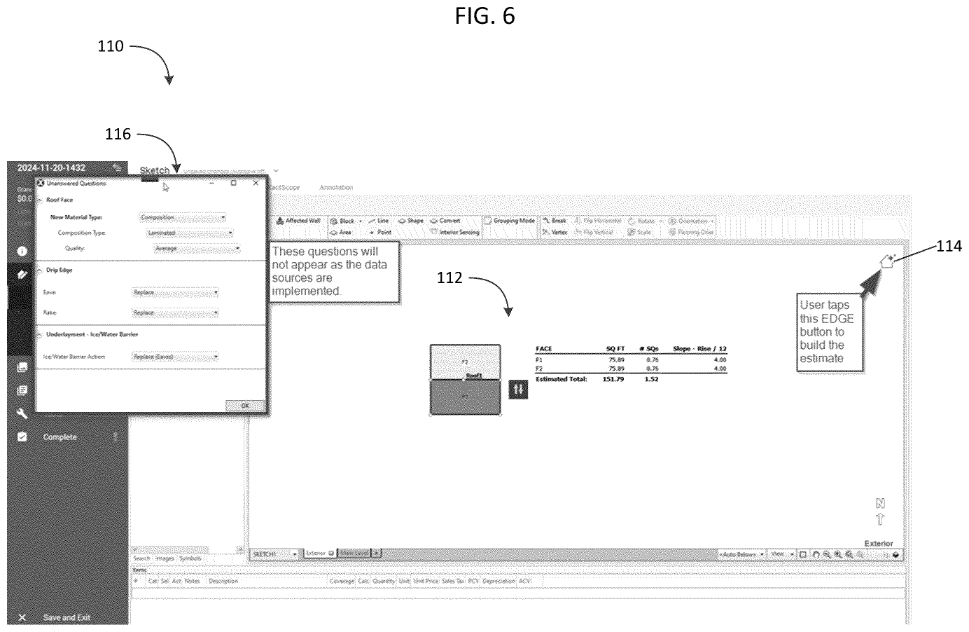

FIG. 6 is a screenshot illustrating a user interface screen 110 generated by the systems and methods of the present disclosure wherein a model of a structure is created and is utilized to automatically create an estimate of elements of the structure. The screen 110 could be displayed on a display of the end-user computing devices 20 of FIG. 1, and allows a user to create a graphical model (sketch) 112 of a structure. As shown in FIG. 6, the model 112 is of a roof of the structure, and includes roof faces F1 and F2. The model 112 could be manually generated by the user (e.g., by drawing the model 112 using a mouse and the user interface screen 110), or automatically using a generative AI model which generates the model 112 automatically based on user inputs (e.g., by the user describing the structure in a conversational (e.g., chatbot-like) interface, or other type of interface). The model 112 could be annotated by answering the questions displayed in panel 116, if desired. Alternatively, the user can click on button 114 once the sketch 112 is complete, which causes the system to automatically generate an estimate for the structure 112, in which case the questions of panel 116 are not displayed to the user. In such circumstances, the user need not answer detailed questions about the roof structure since the system will automatically generate an estimate for the user.

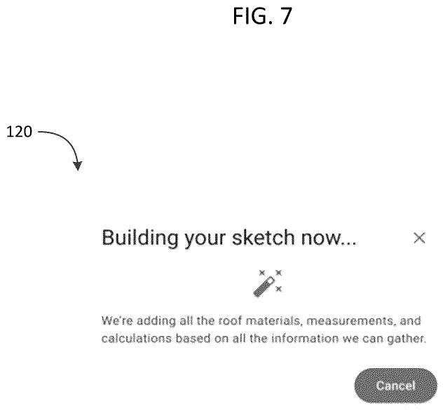

FIG. 7 is screenshot illustrating another user interface screen 120 generated by the systems and methods of the present disclosure, indicating that a model is being created by the system. This screen is displayed when the user clicks on button 114 of the interface 110 of FIG. 6, and indicates to the user that the system is processing all roof materials, measurements, and other information to automatically generate an estimate. The user can choose to cancel automatic estimate generation by clicking the “Cancel” button shown in the screen 120.

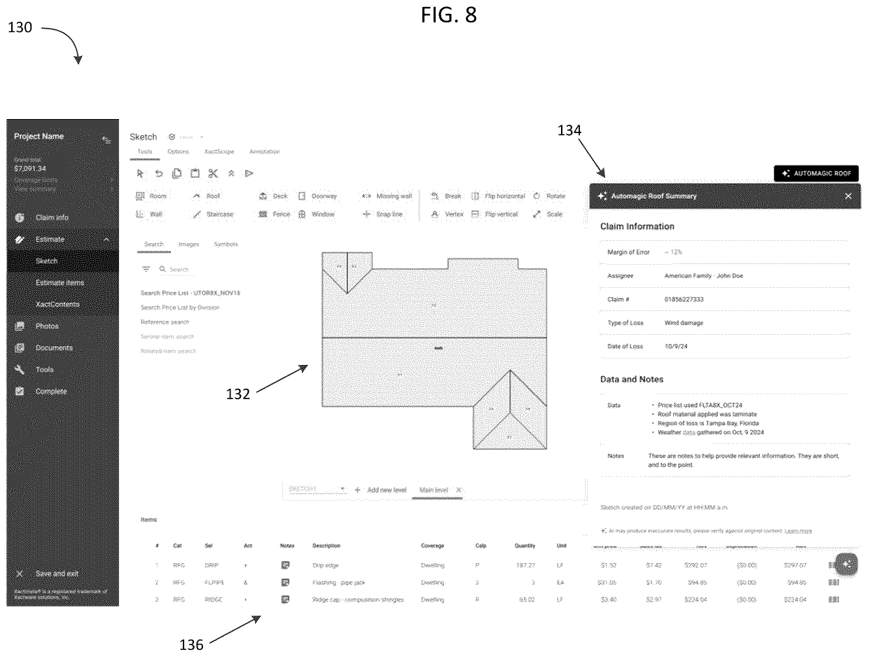

FIG. 8 is screenshot illustrating another user interface screen 130 generated by the systems and methods of the present disclosure, wherein a model of the structure has been created and processed by the system to automatically create a roof summary and a list of repair or replacement components associated with the structure. As can be seen, the model (sketch) 132 of the structure is displayed to the user (which, as discussed above, could be manually created by the user or automatically by the system based on user inputs), as well as an automatic roof summary 134 generated by the system and a complete estimate 136 that lists repair and/or replacement items for use in repairing or replacing one or more components of the structure shown in the model 132. As can be seen, the automatic roof summary 134 includes insurance claim information such as a margin of error, a name of an assignee of the claim, a claim number, a description of the type of loss associated with the claim (e.g., wind damage), and a date of the loss. Additionally, data and notes associated with the claim are also generated and displayed, including price lists utilized by the system, roof material applied by the system, region of loss information, and weather data utilized by the system. The estimate 136 includes a list of repair and/or replacement line items, each of which includes an item number, a “cat” number, a “sel” number, an action indicator, a notes object, a description of the item (e.g., drip edge, flashing, ridge cap, etc.), coverage type, and other information such as quantities of the item, units (e.g., linear feet, square feet, etc.), unit prices, and other pricing information. Both the roof summary 134 and 136 are automatically generated through generative AI as described herein, significantly improving the speed and accuracy with which models and estimates are generated by the system.

It is noted that various types of data can be accessed and utilized by the system. Such data includes, but is not limited to the following:
Property or Geometry data, such as the size and shape of various surfaces in a property, such as roofs, walls, floors, ceilings, etc.
Material data, such as the composition of the roofs, walls, floors, ceilings, etc.
Analytical data, such as the age, quality, estimating guidelines, carrier-specific requirements, local code, etc.
Each data point can be sourced from various places—including but not limited to:
   Previous losses at the same address (historical data)
   Third party integrators
      Third party data can include many of the data points that drive the system, inclusive of property, material, and analytical data
         An example of data points that may be included by third parties is the Material Type of a roof face. This can be added by including the Material and Material Type in the FACE tag for each face.
         <FACE id=“F1” material=“Shake”
         additionalData=“RoofFace.NewMaterial=Shake”>
Other data sources include:
   Respond Map, Providing Weather Data
      Weather data can be used to predict the severity and location of damage to the roof and property. This allows the system to determine the most likely repairs needed for the roof and property.
   Oneclick Code, providing local code that drives specific requirements in the line itemization of the estimate
      Local Code allows the system to determine necessary upgrades and other specific requirements for the repairs to the property
   Local city/county data sources, providing plans, permits, and other sources of data that could drive Geometry or Material data points
      These data points can help to determine Materials, and potentially the geometries of affected faces of the roof and other property data.
   Property Underwriting sources, which could provide data on Geometry and Material data points
      Similar to the local city and county data sources, this may give insight into the materials used in the construction and the geometry of the roof and other property information.
The User
   Users can set up defaults, which will be used when no other source of the data points is available
   Users will be able to adjust settings on the fly, resulting in corrected estimates
Data that can help drive the automation of estimates includes, but is not limited to, the following:
   Roof data
      Roof face action (replace, repair)
      Pitch
      Material Type, Composition Type (varies per Material Type), Quality (varies by Composition Type)
      Height
      Sheathing
         Action
         Type
         Radiant Barrier
      Drip Edge
         Rake
         Eave
         Type
      Ice and Water Shield
         Action
         Replace Eaves
         Replace Roll (36″)
         Replace Full
         Roll Width
         Type
      Underlayment—Felt
         Felt Type
         Double Layer
         Felt Waste
         Joint Taping
      Valley Metal/Flashing
         Action
         Type
      Flashing
         End wall Action
         Flashing Type
         Side wall Action
         Step Flashing Type
      Starter Course
         Eave
         Rake
      Ridge Cap
         Action
         Type
      Soffit/Fascia
         Action
         Components (Fascia Only/Both—Different Materials/Both—Same Materials
         Fascia Material
         Soffit Material
         Include Box Framing
      Soffit Crown Molding
         Action
         Material
      Haul Off
   Exterior
      Exterior Surfaces
         Action (per Material)
         Material Type
         Siding Type (depending on Material Type)
         Style
         Type (depending on Siding Type)
         Scaffolding
         House Wrap
         Light Fixtures
         Motion Sensors
         Exterior Outlets
         Exterior Hose Bib
         Dryer Vent
         Gable Vent
      Windows
         Action
         Material Type
         Type
         Shape
         Quality
         Add-ons
         Retrofit
         Colored Frame
         Glass Strength
         Privacy
         Energy Efficient
         Grid for 2×/3× Glazed
         Aluminum Wrap
      Haul Off
   Water Mitigation
      Geometry of affected wet surfaces
      The material type of affected surfaces
      Equipment type and count used in the drying process
      Equipment readings, allowing automatic creation of daily drying logs
      Likelihood of PPE (Personal Protective Equipment) necessary for the work
      Barriers used
      Time of work done, indicating after-hours work
      Data points gathered from third parties during inspections
      Tear out work completed, including
         Materials bagged for removal & disposal
         Weight
         Haul-off
   Interior Reconstruction/Rebuild

The systems and methods disclosed herein perform predictive estimation, and can leverage a wide variety of data sources in order to automatically generate estimates and to improve the accuracy of such estimates. Examples include, but are not limited to, the following:
Weather data provided by RESPOND Map or other providers can indicate the windspeed, directionality, and hail size of inclement weather. This allows the system to predict specific roof faces, wall surfaces, fences, contents, and wall openings that have been damaged.
Damaged surfaces can be mined for the constituent materials, provided by the third party roof provider, local code, and other sources.
Each of these data points can be leveraged by the system, creating line items based on data-driven heuristics.
As an example, knowing that a roof is shingled with composition roofing, and local code requires Ice & Water Shield on all eaves but not rakes, as well as starter course, sheathing, valley types, etc., can be utilized as a heuristic. Further, with wind at 50 mph from a South-Southwest direction, with hail of ⅝″ size, the system can accurately predict exactly which faces of the roof have been damaged. This, in turn, along with roof age, can help predict whether the roof is likely to require a full replacement or a repair, and based on these assumptions the system can accurately build a list of line items for the most likely scenario.

As mentioned above, the system can utilize one or more programmed heuristics to automatically generate estimates. Such heuristics can, for example, determine specific line items based on available data, inclusive of the geometry and composition of affected surfaces, along with other data points. Rather than presenting to the user the list of data points both known and unknown, the third party data sources can automatically determine the “answers” to those inputs, resulting in a complete estimate. For example, the shape of an object can determine the quantities of line items—a roof face that is 215 square feet results in 215 square feet of roofing, plus waste. Shape can also play a part in whether items such as ice and water shields or starter rows are required. Small faces such as eyebrows (cornice returns) can have special handling as well.

The system can provide a list of data sources from which the estimate was built. This list allows the user to adjust the results by switching to different data providers, or by entering their own preferences. Confidence level quantifiers can be added to this data, allowing users to fine-tune how confident the AI needs to be in its results before line items are generated automatically. Low-confidence items can be available for manual insertion. Line items can be edited manually, changing the quantity, removing items, or adding missing items.

The system can will run rules throughout the process, and can notify the user if there are abnormalities with the estimate. For example, a carrier may require full roof replacement if more than 30% of the square footage is being replaced. If this rule is triggered, it will help to identify when the user needs to carefully review the results.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A generative artificial intelligence system for automated repair and replacement estimation, comprising:
an estimation processor in communication with one or more data sources; and
an estimation generation software engine executed by the estimation processor, the estimation engine causing the estimation processor to:
receive information from the one or more data sources relating to a structure;
generate a computerized model of the structure using the information received from the one or more data sources;
process the computerized model using a trained artificial intelligence model to determine components of the structure;
generate a plurality of line items corresponding to the components; and
generate a final estimate based on the plurality of line items.

2. The system of claim 1, wherein the estimation engine causes the estimation processor to issue a data request to the one or more data sources using a data acquisition Application Programming Interface (API).

3. The system of claim 2, wherein the estimation engine receives the information from the one or more data sources using the API.

4. The system of claim 3, wherein the estimation engine processes the information to identify data points for use in generating the computerized model of the structure.

5. The system of claim 4, wherein the estimation engine reads data relating to one or more objects of the computerized model.

6. The system of claim 5, wherein the estimation engine generates assessments for each of the plurality of line items using the data relating to the one or more objects of the computerized model.

7. The system of claim 1, wherein the information received by the estimation engine comprises property information.

8. The system of claim 7, wherein the estimation engine acquires driver data from one or more of the data sources, the driver data utilized by the estimation engine to automatically generate the final estimate.

9. The system of claim 8, wherein the estimation engine automatically maps the driver data to one or more of the components of the structure.

10. The system of claim 1, further comprising a user interface displayed on a user device, the user interface accepting user input describing the structure and the estimation engine generating the computerized model of the structure based on the user input.

11. A generative artificial intelligence method for automated repair and replacement estimation, comprising:
receiving at an estimation processor information from one or more data sources relating to a structure;
generating by the estimation processor a computerized model of the structure using the information received from the one or more data sources;
processing the computerized model using a trained artificial intelligence model executed by the estimation processor to determine components of the structure;
generating a plurality of line items corresponding to the components; and
generating a final estimate based on the plurality of line items.

12. The method of claim 11, further comprising issuing by the estimation processor a data request to the one or more data sources using a data acquisition Application Programming Interface (API).

13. The method of claim 12, further comprising receiving the information from the one or more data sources using the API.

14. The method of claim 13, further comprising processing the information to identify data points for use in generating the computerized model of the structure.

15. The method of claim 14, further comprising reading data relating to one or more objects of the computerized model.

16. The method of claim 15, further comprising generating assessments for each of the plurality of line items using the data relating to the one or more objects of the computerized model.

17. The method of claim 11, wherein the information received by the estimation processor comprises property information.

18. The method of claim 17, further comprising acquiring by the estimation processor driver data from one or more of the data sources, the driver data utilized by the estimation processor to automatically generate the final estimate.

19. The method of claim 18, further comprising automatically mapping the driver data to one or more of the components of the structure.

20. The method of claim 11, further comprising displaying a user interface on a user device, the user interface accepting user input describing the structure and the estimation engine generating the computerized model of the structure based on the user input.
